(19) United States
(12) Patent Application Publication
(10) Pub. No.: US 2026/0223949 A1
(43) Pub. Date: Aug. 6, 2026

(54) RF ENERGY HARVESTING FOR AUTHENTICATION TAG OF CONSUMABLE CONTAINER

(71) Applicant: PHILIP MORRIS PRODUCTS S.A., Neuchatel (CH)

(72) Inventors: Rui Nuno Rodrigues Alves BATISTA, Morges (CH); Frederic Philippe Christophe NICOLAS, Moret-Loing-et-Orvanne (FR); Cristina FERRAZ RIGO, Pully (CH)

(21) Appl. No.: 19/152,483

(22) PCT Filed: Feb. 2, 2024
(86) PCT No.: PCT/EP2024/052596

§ 371 Date: Jul. 31, 2025

(30) Foreign Application Priority Data
Feb. 3, 2023 (EP) 23154934.6

(51) Int. Cl. A24F 40/53; A24F 15/01; A24F 40/42; A24F 40/65; B65D 55/14; B65D 85/10; G06F 21/35

(52) U.S. Cl. CPC A24F 40/53; A24F 15/01; A24F 40/42; A24F 40/65; B65D 55/14; B65D 85/1081; G06F 21/35

(57) ABSTRACT

A system and method for using consumables with an electronic device is provided. The system comprises an electronic device configured to consume consumables; and a container configured to store consumables, the container comprising a tag, wherein the electronic device is configured to read an identifier from the tag, and wherein the electronic device is configured to unlock, based on the identifier, at least one function of the electronic device.

The present disclosure relates to operating electronic devices configured for using consumables provided in containers.

Consumables or consumable articles are non-durable articles, which can be used for immediate consumption. These consumables can interact with an electronic device or can be used by an electronic device. These consumables may be provided in containers, such as packs or boxes, configured to store a plurality of consumables.

However, a problem with such consumables for usage by an electronic device is the counterfeit of consumables. A manufacturer of the electronic device for using consumables has no control of these counterfeits of consumables and does not know how these consumables are generated or what the counterfeits of consumables are made of. Accordingly, the manufacturer of the electronic device for using consumables cannot guarantee that that there will be no danger to users of the electronic device or the electronic device when counterfeits of consumables are used.

Securing each consumable with an anti-counterfeit system is an option, which can be costly in terms of manufacturing. Another problem is that the anti-counterfeit system can be attacked. Accordingly, it may be desired to provide a reliable and secure anti-counterfeit system. Depending on the number of consumables, it may be difficult to uniquely identify or authenticate each consumable or to provide for a desired level of protection.

Accordingly, it would be desirable to provide a reliable and efficient method for using consumables with an electronic device in a secure manner.

According to an aspect of the present invention, there is provided a system comprising an electronic device configured to consume consumables; and a container configured to store consumables, the container comprising a tag, wherein the electronic device is configured to read an identifier from the tag, and wherein the electronic device is configured to unlock, based on the identifier, at least one function of the electronic device.

By providing a tag comprised in the container, an efficient and reliable counterfeit measure is provided.

According to aspects, the tag may be powered by a radio-frequency energy harvesting, RF-EH, system. By using a radio-frequency energy harvesting, RF-EH, system comprised in the container to power the tag, a range for reading the tag can be increased such that the container does not need to be in close proximity to the electronic device. Additionally, the tag can be powered using ambient radio frequency signals. Accordingly, the tag or the container does not need to be connected to an external power source for authenticating the consumables or the container.

According to aspects, the identifier used for identifying or authenticating the container may be used only a limited amount of times to unlock the at least one function of the electronic device.

The limited amount of times may correspond to a maximum number of consumables in the container. By limiting the amount of times an identifier can be used to unlock the at least one function of the electronic device, it can be prevented that the counterfeit consumable is used or consumed based on a single identifier of a genuine container.

According to aspects, the container may be configured to transition from a sealed state to an unsealed state when the container is opened for the first time. The identifier may only be read in the unsealed state. Alternatively, the electronic device may be configured to read information about whether the state of the container is sealed or unsealed from the tag. In this case, the electronic device may be configured to unlock the at least one function of the electronic device based on the identifier only when the information about whether the state of the electronic device is sealed or unsealed indicates that the container is unsealed. This avoids that counterfeit consumables can be used by unlocking the electronic device based on identifiers of sealed containers, which may be in a store for containers of consumables.

According to aspects, at least a part of the identifier may be encrypted, such that the electronic device is configured to read the encrypted identifier and to decrypt the read encrypted identifier. This adds to the security of the system and prevents third parties from generating counterfeit products having authentic identifiers, which may be obtained from analysing an unencrypted identifier.

According to aspects, additional information may be comprised in a backscattered signal from the container to configure said container. The electronic device may be configured to send a radio frequency signal to the container, and receive a backscattered signal from the container when reading the identifier from the tag. The backscattered signal may comprise the identifier and the information for configuring the electronic device. For example, the configuring of the electronic device may comprise selecting a temperature profile from a plurality of temperature profiles and operating the electronic device in accordance with the selected temperature profile. This allows configuring the electronic device differently in accordance with a type of the consumables such that parameters of the electronic device can be adapted to achieve the best result for different types of consumables.

According to another aspect of the present invention, there is provided a method for using consumables with an electronic device. The method comprises requesting, by an electronic device for using consumables, usage of a consumable from a container storing consumables by sending a radio frequency signal to a tag of a container; receiving, by the electronic device, a backscattered signal from the tag of the container, wherein the backscattered signal comprises an identifier identifying at least one of the consumable and the container; and operating the electronic device to use the consumable when the at least one of the consumable and the container is identified based on the received identifier.

According to aspects, the method may comprise blocking at least one functionality of the electronic device making the electronic device unable to use the consumable, in response to not receiving the backscattered signal, e.g. in a certain or predefined amount of time after sending the radio frequency signal, or in response to determining, based on the identifier, that the identified at least one of the consumable and the container is a counterfeit product. This may prevent usage of counterfeit consumables and may restrict the usage of consumables to certain consumables, which may have been certified or granted by a manufacturer of the electronic device.

According to aspects, the electronic device may be configured to send a message to a server in response to reading the identifier. The message may comprise the identifier or information associated with the container, wherein the server is configured to analyse at least the message and other messages from one or more electronic devices. The electronic device may be updated based on the analysis. By analysing a plurality of messages from a plurality of electronic devices, copies of an identifier, which may be a unique identifier, of containers may be detected. In case of a unique identifier, this allows determining that an identifier has been used by a third party to produce counterfeit consumables. Countermeasures can then be taken. For example, electronic devices can be instructed to permanently lock the at least one function of the electronic device for the copied identifier.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomizer, such as an electric heater, to heat the aerosol-forming substrate to form an aerosol.

As used herein, the term “aerosol-forming substrate disposed in and/or engaged with the aerosol-generating device” refers to the combination of an aerosol-generating device with an aerosol-forming substrate. When the aerosol-forming substrate forms part of an aerosol-generating article, the aerosol-forming substrate disposed in and/or engaged with the aerosol-generating device refers to the combination of the aerosol-generating device with the aerosol-generating article. The aerosol-forming substrate and the aerosol-generating device may cooperate to generate an aerosol.

As used herein, the term “aerosol-forming substrate” refers to a substrate capable of releasing volatile compounds that can form an aerosol. The volatile compounds may be released by heating the aerosol-forming substrate. As an alternative to heating, in some cases, volatile compounds may be released by a chemical reaction or by a mechanical stimulus, such as ultrasound. The aerosol-forming substrate may be solid or may comprise both solid and liquid components. An aerosol-forming substrate may be part of an aerosol-generating article.

As used herein, the term “aerosol-generating article” refers to an article comprising an aerosol-forming substrate that is capable of releasing volatile compounds that can form an aerosol. The aerosol may comprise nicotine. An aerosol-generating article may be disposable.

An aerosol-generating article comprising an aerosol-forming substrate comprising tobacco may be referred to herein as a tobacco stick.

An aerosol-forming substrate may comprise nicotine. An aerosol-forming substrate may comprise tobacco, for example a tobacco-containing material containing volatile tobacco flavor compounds, which are released from the aerosol-forming substrate upon heating. In preferred embodiments an aerosol-forming substrate may comprise homogenized tobacco material, for example cast leaf tobacco. The aerosol-forming substrate may comprise both solid and liquid components. The aerosol-forming substrate may comprise a tobacco-containing material containing volatile tobacco flavor compounds, which are released from the substrate upon heating. The aerosol-forming substrate may comprise a non-tobacco material. The aerosol-forming substrate may further comprise an aerosol former. Examples of suitable aerosol formers are glycerin and propylene glycol.

As used herein, the term “container”, refers to a storage, such as a pack or box of several consumables or of several consumable doses.

The invention is defined in the claims. However, below there is provided a non-exhaustive list of non-limiting examples. Any one or more of the features of these examples may be combined with any one or more features of another example, embodiment, or aspect described herein.

Example Ex1. A system comprising:
an electronic device configured to consume consumables; and
a container configured to store consumables, the container comprising a tag,
wherein the electronic device is configured to read an identifier from the tag, and
wherein the electronic device is configured to unlock, based on the identifier, at least one function of the electronic device.

Example Ex2. The system according to Ex1, wherein the electronic device comprises an aerosol-generating device and is configured to unlock, based on the identifier, at least one function of the aerosol-generating device in response to reading the identifier.

Example Ex3. The system according to Ex2, wherein the consumables comprise aerosol-generating articles, wherein the aerosol-generating device is configured to engage with an aerosol-generating article of the aerosol-generating articles.

Example Ex4. The system according to Ex3, wherein the electronic device is configured to heat the aerosol-generating article only when a container is authenticated based on the identifier.

Example Ex5. The system according to one of Ex1 to Ex4, wherein the electronic device is configured to:
send a radio frequency signal to the container, and
receive a backscattered signal from the container to read the identifier from the tag, the backscattered signal comprising the identifier.

Example Ex6. The system according to one of Ex1 to Ex5, wherein the container is one of a pack, a storage or a box.

Example Ex7. The system according to one of Ex1 to Ex6, wherein the identifier is used only a limited amount of times to unlock the at least one function.

Example Ex8. The system according to Ex7, wherein the limited amount of times corresponds to the maximum number of consumables in the container.

Example Ex9. The system according to one of Ex1 to Ex8, wherein the container is configured to transition from a sealed to an unsealed state when the container is opened for the first time.

Example Ex10. The system according to Ex9, wherein the identifier is only read in the unsealed state.

Example Ex11. The system according to one of Ex9 to Ex10, wherein the transition from the sealed to the unsealed state comprises opening a circuit connected to the tag.

Example Ex12. The system according to Ex11, wherein the transition from the sealed to the unsealed state comprises permanently opening the circuit connected to the tag when the container is opened for the first time.

Example Ex13. The system according to Ex5, wherein the backscattered signal comprises information about whether a state of the container is sealed or unsealed.

Example Ex14. The system according to Ex13, wherein the electronic device is configured to unlock the at least one function of the electronic device based on the identifier only when the information about whether the state of the container is sealed or unsealed indicates that the container is unsealed.

Example Ex 15. The system according to one of Ex1 to Ex14, comprising a server, wherein the electronic device is configured to send a message to the server in response to reading the identifier, wherein the message comprises the identifier or information associated with the container, wherein the server is configured to analyze at least the message.

Example Ex16. The system according to Ex15, wherein the electronic device is updated based on the analysis.

Example Ex17. The system according to one of Ex15 and Ex16, wherein the server is configured to analyze a plurality of messages, including the message, from a plurality of electronic devices, wherein each of the messages comprises a unique identifier associated with a container, wherein the server is configured to detect copies of the identifier in messages from different electronic devices.

Example Ex18. The system according to Ex17, wherein the server is configured to instruct all electronic devices to permanently lock the at least one function of the electronic device for the copied identifier.

Example Ex19. The system according to one of Ex15 to Ex18, wherein the message comprises a geo location of the electronic device sending the message.

Example Ex20. The system according to one of Ex1 to Ex19, wherein the tag is configured to:
receive a radio frequency signal from the electronic device or a mobile computing device, and
backscatter, in response to receiving the radio frequency signal, a modulated radio frequency signal to the electronic device or the mobile computing device.

Example Ex21. The system according to Ex20, wherein the tag is configured to modulate a frequency of the received radio frequency signal to obtain the modulated radio frequency signal.

Example Ex22. The system according to one of Ex20 and Ex21, wherein the tag is configured to modulate the amplitude of the radio frequency signal to obtain the modulated radio frequency signal.

Example Ex23. The system according to one of Ex20 to Ex22, wherein the tag is configured to modulate a carrier wave of the radio frequency signal by adjusting one of an impedance and a capacitance.

Example Ex24. The system according to one of Ex1 to Ex23, wherein the identifier is unique per container.

Example Ex25. The system according to Ex24, wherein the unique identifier of the container is a manufacturing information block, MIB.

Example Ex 26. The system according to one of Ex1 to Ex25, wherein at least a part of the identifier is encrypted.

Example Ex27. The system according to one of Ex1 to Ex26, wherein the identifier is sent along with a message authentication code, MAC, of the identifier.

Example Ex 28. The system according to Ex27, wherein the message authentication code uses a signature hash-based MAC, HMAC.

Example Ex29. The system according to Ex28, wherein a secret key used by the HMAC is generated using a key derivative function, KDF.

Example Ex30. The system according to one of Ex1 to Ex29, wherein the identifier is associated with a kind of container and is unique per kind of container.

Example Ex31. The system according to one of Ex1 to Ex30, wherein each kind of container is associated with a secret key.

Example Ex32. The system according to one of Ex20 to Ex22, wherein all secret keys for all kinds of containers are stored in the electronic device.

Example Ex33. The system according to one of Ex24 and Ex25, wherein the electronic device is configured to securely connect to a server to retrieve a shared secret key using the unique identifier.

Example Ex34. The system according to Ex 9, wherein the KDF is a hash based KDF, HKDF, and a non-secret parameter of the HKDF is the MIB.

Example Ex35. The system according to Ex29, wherein a signature generated by the HMAC is truncated.

Example Ex36. The system according to Ex5, wherein the electronic device is configured based on information comprised in the backscattered signal.

Example Ex37. The system according to Ex36, wherein the configuring comprises selecting a temperature profile from a plurality of temperature profiles and operating the electronic device in accordance with the selected temperature profile.

Example Ex38. The system according to one of Ex1 to Ex37, wherein at least one setting of the electronic device is configured based on the identifier.

Example Ex39. The system according to one of Ex5 and Ex36, wherein the backscattered signal comprises an encrypted message, EMS, a generic identification, GID, of a kind of the consumables and a unique identification value of the container for container authentication.

Example Ex 40. The system according to Ex39, wherein the EMS is created by using a symmetric-key algorithm.

Example Ex41. The system according to one of Ex1 to Ex40, wherein the container comprises a radio-frequency energy harvesting, RF-EH, system to power the tag, wherein the RF-EH system comprises an antenna.

Example Ex42. The system according to Ex41, wherein the RF-EH system provides energy for the tag for backscattering the signal.

Example Ex43. The system according to one of Ex41 and Ex42, wherein the RF-EH system is configured to generate electrical energy from ambient radio frequency signals.

Example Ex44. The system according to one of Ex41 to Ex43, wherein the RF-EH system comprises an impedance matching circuit, a rectifier configured to convert alternating current, AC, to direct current, DC, and the energy storage.

Example Ex45. The system according to one of Ex41 to Ex44, wherein the antenna of the RF-EH system is configured to receive a range of radio frequencies that is broader compared to a radio frequency range for an antenna of the tag for backscattering an incoming signal.

Example Ex46. The system according to one of Ex41 to Ex45, wherein the range of the antenna of the tag powered by the RF-EH system is more than one of 10 meters, 12 meters, 15 meters, 20 meters, 30 meters and 50 meters.

Example Ex47. The system according to one of Ex41 to Ex46, wherein the range of the antenna of the tag powered by the RF-EH system is less than 100 meters.

Example Ex48. The system according to one of Ex41 to Ex47, wherein the RF-EH system is charged at factory time.

Example Ex49. The system according to one of Ex41 to Ex48, wherein the electronic device is configured to request from a user of the electronic device and the consumable to bring the container in proximity to a radio frequency source before consuming one or more of the consumables to charge the energy storage of the RF-EH system.

Example Ex50. The system according to one of Ex41 to Ex49, wherein the antenna of the RF-EH system is printed on at least one surface of the container.

Example Ex51. The system according to one of Ex41 to Ex50, wherein the antenna of the RF-EH system is printed on at least one inner surface of the container.

Example Ex52. The system according to one of Ex1 to Ex37, wherein the antenna of the RF-EH system is a layer of packaging material of the container.

Example Ex53. The system according to Ex52, wherein the packaging material is laminated.

Example Ex54. The system according to one of Ex41 to Ex53, wherein at least one of:
the antenna is comprised in at least one of the walls of the container,
the antenna is deposed in the cardboard of the container, and
an inner liner of the container comprises the antenna, wherein the inner liner comprises metal.

Example Ex55. The system according to Ex44, wherein the energy storage comprises at least one of a capacitor and a battery.

Example Ex56. The system according to one of Ex1 to Ex40, wherein the tag comprises a radio frequency identification, RFID, circuit.

Example Ex57. The system according to Ex1, wherein the electronic device comprises a mobile computing device, and the consumable comprises an aerosol-generating article, wherein the mobile computing device is configured to instruct an aerosol-generating article to unlock, based on the identifier, at least one function of the electronic device.

Example Ex58. A method for using consumables with an electronic device, the method comprising:
requesting, by an electronic device for using consumables, usage of a consumable from a container storing consumables by sending a radio frequency signal to a tag of a container;
receiving, by the electronic device, a backscattered signal from the tag of the container, wherein the backscattered signal comprises an identifier identifying at least one of the consumable and the container; and
operating the electronic device to use the consumable when the at least one of the consumable and the container is identified based on the received identifier.

Example Ex59. The method according to Ex58, wherein the consumables comprise aerosol-generating articles, wherein the electronic device comprises an aerosol-generating device configured to engage with an aerosol-generating article of the aerosol-generating articles. Example Ex60. The method according to one of Ex58 and Ex59, wherein the backscattered signal comprises information associated with the consumables, and wherein the method comprises configuring the electronic device based on the information.

Example Ex61. The method according to Ex60, wherein the information comprises an indication of a heat profile for heating the consumable.

Example Ex62. The method according to one of Ex58 to Ex61 comprising blocking at least one functionality of the electronic device making the electronic device unable to use the consumable, in response to not receiving the backscattered signal or determining, based on the identifier, that the identified at least one of the consumable and the container is a counterfeit product.

Example Ex63. The method according to one of Ex58 to Ex62 comprising notifying a user of the electronic device in response to not receiving the backscattered signal or determining, based on the identifier, that the at least one of the consumable and the container is a counterfeit product.

Example Ex64. The method according to one of Ex58 to Ex63, wherein the operating the electronic device to use the consumable is limited to a predetermined number of times for the identifier.

Example Ex65. The method according to one of Ex58 to Ex64, wherein the backscattered signal from the tag is only received when a state of the container has been transitioned from a sealed state to an unsealed state.

Example Ex66. The method according to Ex65, wherein the transitioning from a sealed state to an unsealed state comprises opening a current line connected to the tag when the container is opened for the first time, the current line creating a short cut preventing the tag from backscattering a signal.

Example Ex67. The method according to one of Ex65 and Ex66, wherein the transitioning from a sealed state to an unsealed state comprises activating a load modulator of the tag, when the container is opened for the first time.

Example Ex68. The method according to one of Ex65 to Ex67, wherein the transitioning from a sealed state to an unsealed state comprises opening a current line bypassing one load of the tag when the container is opened for the first time, the current line creating a shortcut preventing the tag from backscattering a signal.

Example Ex69. The method according to one of Ex58 to Ex64, wherein the backscattered signal comprises information about a state of the container, wherein the state is one of a sealed state and an unsealed state.

Example Ex70. The method according to one of Ex58 to Ex63, wherein the method further comprises:
sending a first RF signal to the tag of the container being in a sealed state;
receiving a first backscattered signal comprising the identifier and an indication of the sealed state;
recording the identifier;
sending a second RF signal to the tag of the container having transitioned from the sealed state to an unsealed state;
receiving a second backscattered signal comprising the identifier and an indication of the unsealed state;
determining that the container has been transitioned from the sealed state to the unsealed state based on the first and the second backscattered signal;
crediting the electronic device with a number of consumables that can be used from the unsealed container; and
each time a consumable of the container is engaged with the electronic device, the electronic device performs:
the requesting the usage of the consumable;
the receiving of the backscattered signal comprising the identifier;
checking that the identifier has been recorded;
decreasing the number of consumables; and
the using the consumable.

Example Ex71. The method according to Ex70, wherein the electronic device is prevented from using the consumable when the number of consumables has been depleted.

Example Ex72. The method according to one of Ex58 to Ex71 comprising transferring a remaining number of consumables in a container to a different electronic device for usage of remaining consumables in the container.

Example Ex73. The method according to one of Ex58 to Ex63, wherein the backscattered signal comprises information regarding at least one parameter of the electronic device, wherein the electronic device is configured based on the at least one parameter.

Example Ex74. The method according to one of Ex58 to Ex73, wherein at least one setting of the electronic device is configured based on the identifier.

Example Ex75. The method according to one of Ex73 and Ex74, wherein the configuring comprises selecting a temperature profile from a plurality of temperature profiles and operating the electronic device in accordance with the selected temperature profile for the consumables of the container.

Example Ex76. The method according to one of Ex58 to Ex75, wherein the container comprises a radio-frequency energy harvesting, RF-EH, system for providing energy for the tag for backscattering the radio frequency signal.

Example Ex77. The method according to Ex76, wherein the container comprises a metallic inner liner, wherein the metallic inner liner comprises an antenna of the RF-EH system.

Example Ex78. The method according to one of Ex58 to Ex75, wherein the tag is an RFID tag.

Example Ex79. The method according to one of Ex58 to Ex78 comprising:
refilling the container with consumables;
assigning a new identifier to the container; and
sealing the container.

Examples will now be further described with reference to the figures in which:

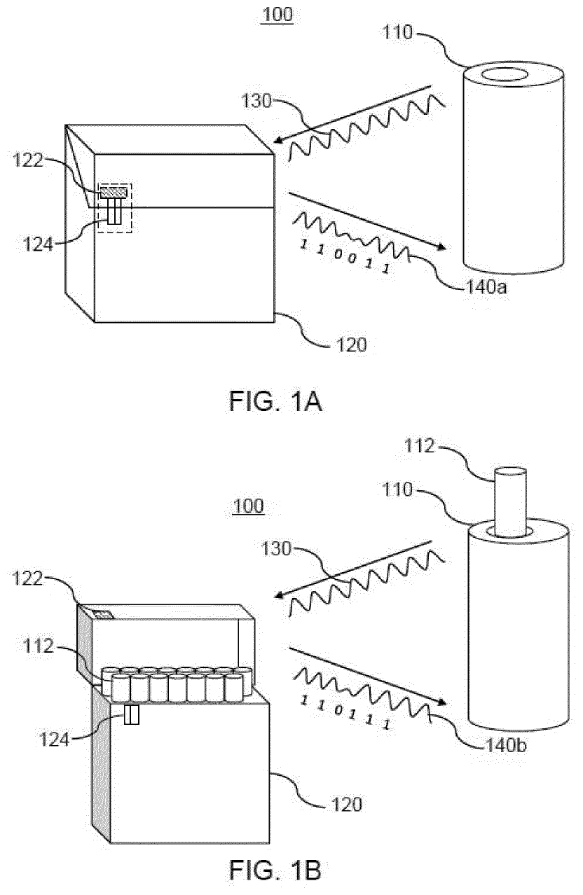

FIG. 1A shows a schematic illustration of a system in a first state according to an aspect;

FIG. 1B shows a schematic illustration of a system in a second state according to an aspect;

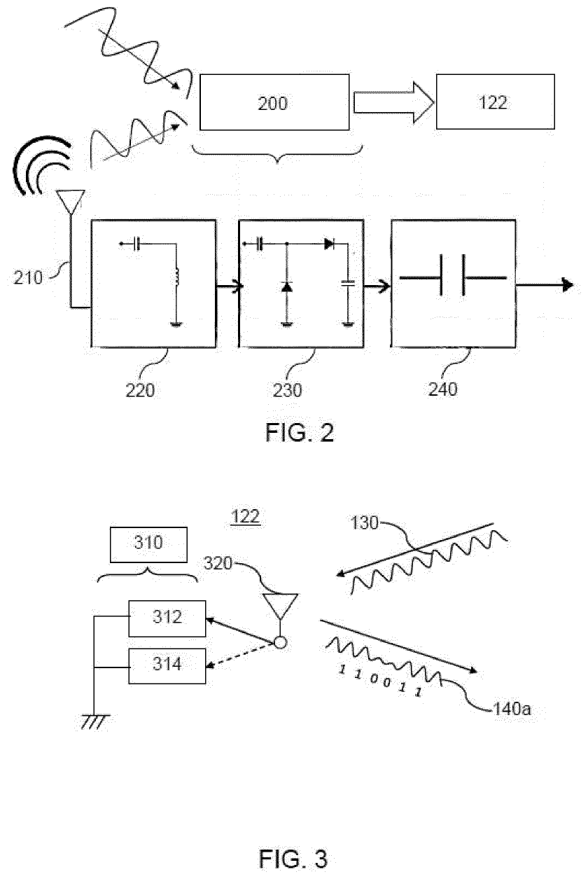

FIG. 2 shows a schematic illustration of a radio-frequency energy harvesting, RF-EH, system for powering a tag according to an aspect;

FIG. 3 shows a schematic illustration of a tag according to an aspect;

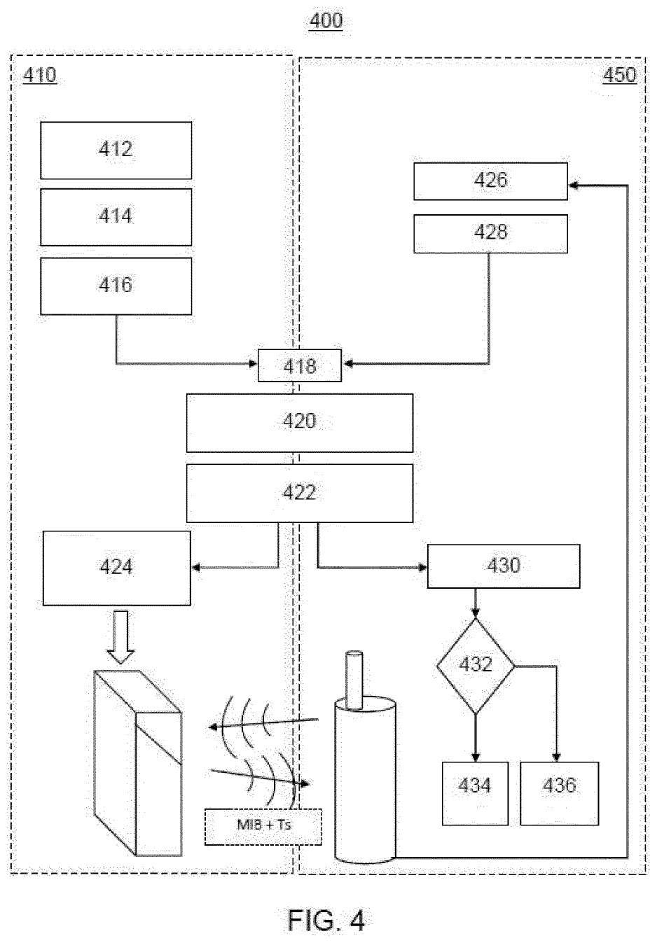

FIG. 4 shows a flow diagram of a method for generating encrypted identifier for a tag of a container, and an authentication method performed by an electronic device according to an aspect;

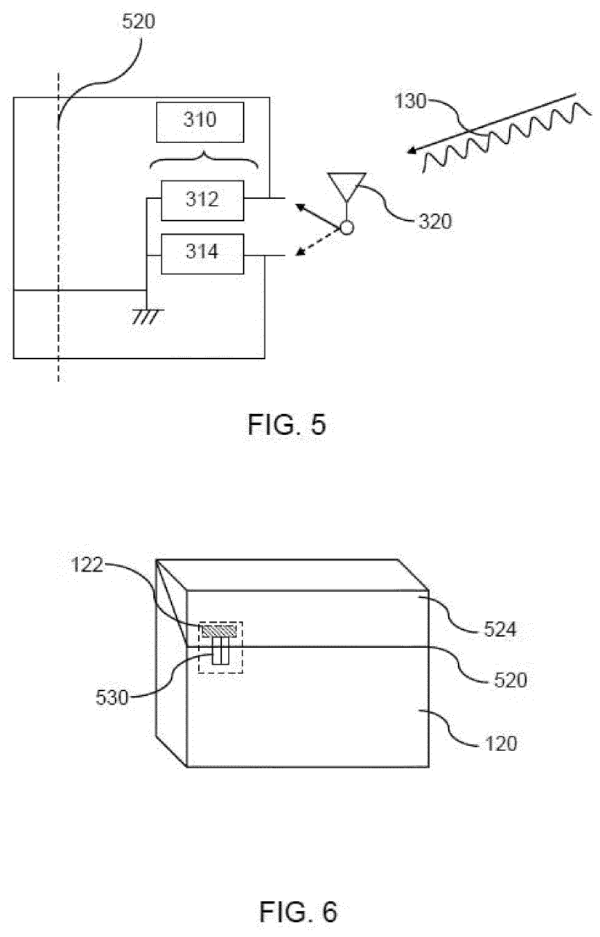

FIG. 5 shows a schematic illustration of a circuit suppressing the backscattered signal of the tag;

FIG. 6 shows a schematic illustration of a container with a tag according to an aspect; and

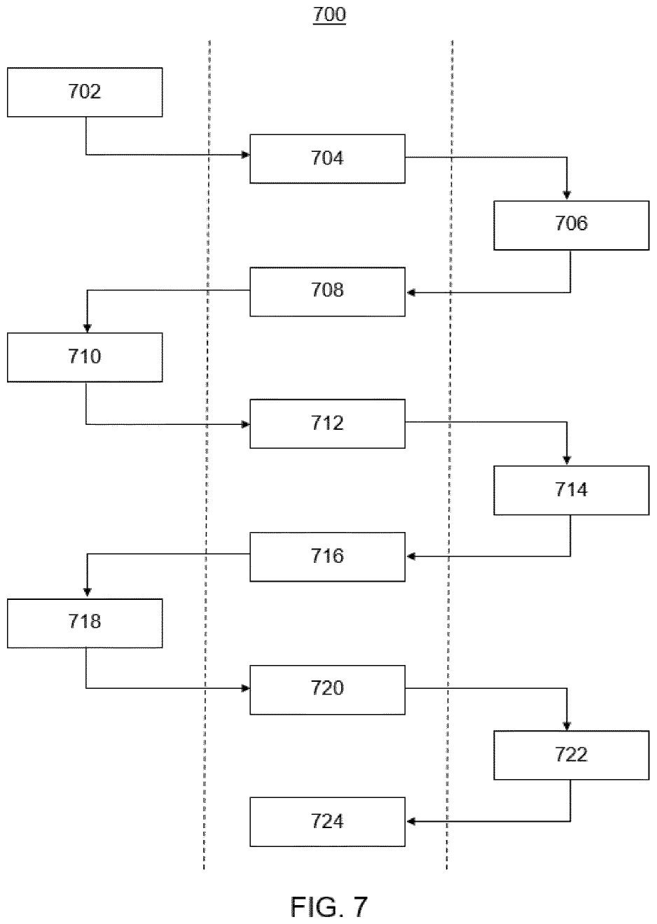

FIG. 7 shows a flow diagram for receiving a credit for using consumables according to an aspect.

Aspects will be described with respect to aerosol-generating (or providing) systems using an electronic device (“RRP device”) and consumables provided in containers, such as packs and boxes. A container may comprise a bottle of e-liquid, with a cylindrical shape, and parallelepiped cellulose-based packaging. An RRP system may comprise a Heat not Burn (“HnB”) system, which may be based on a resistive or inductive heating system, for external or internal heating of consumables, such as cylindrical consumables.

Consumption of illegal counterfeit consumables with an RRP device may generate aerosols out of a manufacturer specification, which can be harmful to consumers, putting the health of consumers at risk.

Securing each consumable with an anti-counterfeit system is an option that can be costly in terms of manufacturing, and may increase complexity in handling of the consumables.

It would be desirable to find a reliable and feasible solution to avoid the commercialization and use of counterfeit consumables in PMI RRP original devices.

FIG. 1A illustrates a system 100 in a first state according to an aspect. The system 100 comprises an electronic device 110 configured to consume consumables 112, and a container 120 configured to store consumables 112. The container comprising a tag 122. The electronic device 110 is configured to read an identifier from the tag 122. To read the identifier, the electronic device may send a radio frequency signal 130 to the container 120. The tag 122 receives the radio frequency signal from the electronic device 110, and backscatters, in response to receiving the radio frequency signal, a modulated radio frequency signal 140 to the electronic device 110.

The electronic device may receive the backscattered signal 140 from the container to read the identifier from the tag 122. The backscattered signal 140 comprises the identifier.

The container 120 may be in one of two states. For example, the container 120 may be in a first state, such as a sealed state as shown in FIG. 1A. Alternatively, the container 120 may be in a second state, such as an unsealed state as shown in FIG. 1B. The container 120 may transition from the sealed state to the unsealed state when the container 120 is opened for the first time.

In one aspect, the identifier can only be read in the unsealed state. In another aspect, the electronic device 110 can read information about whether the state of the container is sealed or unsealed from the tag. For example, the backscattered signal 140 may be modulated differently depending on the state of the container 120. Signal 140a indicates the sealed state of the container 120, and signal 140b indicates the unsealed state of the container 120.

The tag 122 may be configured to modulate a frequency of the received radio frequency signal 130 to obtain the modulated radio frequency signal 140. Alternatively, the tag may be configured to modulate the amplitude of the radio frequency signal 130 to obtain the modulated radio frequency signal 140. The tag 122 may modulate a carrier wave of the radio frequency signal 130 by adjusting one of an impedance and a capacitance.

The transition from the sealed to the unsealed state of the container 120 may comprises opening a circuit 124 connected to the tag. The circuit may be opened permanently by destroying a connection line of the circuit when the container is opened for the first time.

The electronic device 110 is configured to unlock, based on the identifier, at least one function of the electronic device 110. The electronic device 110 may be configured to unlock the at least one function of the electronic device based on the identifier only when the information about whether the state of the container 110 is sealed or unsealed indicates that the container is unsealed.

The electronic device 110 may be an aerosol-generating device and may be configured to unlock, based on the identifier, at least one function of the aerosol-generating device in response to reading the identifier. The consumables 112 may be aerosol-generating articles. The aerosol-generating device may be configured to engage with an aerosol-generating article of the aerosol-generating articles, as shown in FIG. 1A. The locked function of the electronic device may comprise heating the aerosol-generating article. The electronic device 110 may only heat the aerosol-generating article when a container is authenticated based on the identifier.

According to an aspect, the system 100 comprises a container for consumables and an associated electronic device, such as an RRP device. The container 120 may comprise a Radio-Frequency Energy Harvesting (“RF-EH”) system embedded in the container 120. The tag 122 may be connected to the RF-EH and may be powered by the RF-EH. The tag 122 may store a unique identifier of the container 120. The electronic device may include an RF function allowing it to read the unique identifier. According to the unique identifier, the electronic device could identify or classify the container as genuine or not, and accordingly, limit or not its functionalities (for instance, the electronic device could start working/heating a consumable only if a genuine container is provided). A genuine container, identified or classified by its unique identifier, could be used only a limited number of times corresponding to the usual or maximum number of consumables in such kind of pack.

The backscattered signal 140 may be provided only if the container is open, e.g. unsealed.

According to this additional condition, the electronic device could have an even more efficient filter versus counterfeit, as it needs the proximity of a genuine unsealed pack before working, and such a genuine unsealed pack could be used only a limited number of times.

The backscattered signal may also include the current state of the container, “sealed” or “unsealed”. According to this signal and the variation of the state of the container, the electronic device could become “proprietary” of the number of consumables included in the pack. This provides for an effective system against counterfeit consumables.

The backscattered signal may include information about the specific type of consumables in the container, in order to automatically set-up the electronic device in the best way for the consumable's consumption, such as a specific temperature profile. The classification information sent to the electronic device could also be used to feedback information to the product manufacturer.

The proper functioning of the electronic device may need the proximity of a genuine container, preferably open, strongly limiting the use of a counterfeit, while not adding burden for the legal consumers thanks to the somewhat long distance backscattering property of the tag connected to the RF-EH system.

The authentication method is applied to containers and not to each consumable, decreasing its cost and complexity.

The small tag-size, low cost and zero-battery/zero-maintenance properties of the RF-EH and tag system may be compliant with the packaging constraints for the consumables. Regarding the electronic device, the needed radio frequency (RF) function (which can allow the direct reading of the backscattered RF or can be a wireless connection to a smartphone able to do so) can be a “standard” for electronic devices.

According to one aspect, the system 100 may comprise a plurality of elements, including at least one electronic device 120 for aerosolization, which directly interfaces with a container 120 for consumables. The container comprises an antenna for RF-Energy Harvesting, namely for the purpose of sending a reliable low power signal that is received by the electronic device, exemplarily informing about the authenticity of the consumable 112, as an original product or article. The signal may comprise information about the specific type of consumable, in order to automatically set-up the electronic device, such as to automatically set-up a specific temperature profile. The container may be configured by incorporating an antenna with a specific design or layout, deposited in at least one surface of the container, such as a cardboard or an inner liner, which already has a metalized layer, of the container or pack.

According to an aspect, FIGS. 1A and 1B show an RF-EH tag backscattering an incoming RF signal sent by an electronic device, such as an RRP device, including in the backscattered signal (1), the ID of the container 120 allowing the electronic device to check if the container is genuine and, if so, allowing the electronic device to operate and to heat a consumable, and (2) the status (sealed/unsealed) of the container.

In FIG. 1A, the backscattered signal includes the status “sealed” of the container. In FIG. 1B, the electronic device, before heating a consumable, sends a RF signal to the container. The opening of the container has modified the RF-EH tag. For example, at least one current line may have been torn open in the opening process of the container, which now allows for the sending of an “unsealed” status with the ID of the pack.

FIG. 2 shows a schematic illustration of a radio-frequency energy harvesting, RF-EH, system 200 for powering a tag 122 according to an aspect. The container 120 may comprise the radio-frequency energy harvesting, RF-EH, system 200 to power the tag 122. The RF-EH system comprises an antenna 210. The antenna 210 of the RF-EH system 200 may be printed on at least one surface of the container. The antenna 210 of the RF-EH system 200 may be a layer of packaging material of the container. The antenna 210 of the RF-EH system 200 may be comprised in at least one of the walls of the container. The antenna 210 of the RF-EH system 200 may be deposed in the cardboard of the container. The antenna 210 of the RF-EH system 200 may be comprised in an inner liner of the container. The inner liner comprises metal.

The antenna 210 of the RF-EH system 200 may be configured to receive ambient RF signals, such as signals from wireless networks, mobile phones or TV stations.

The RF-EH system 200 may be embedded in the container at factory time. Radio-Frequency Energy Harvesting (“RF-EH”) allows generating electrical energy from ambient or surrounding RF signals. This energy can be used to “backscatter” a RF signal such as RF signal 130. Backscattering a signal may comprise sending back a radio frequency signal with added information, by modulating the frequency or the amplitude of the carrier wave of the incoming RF signal. This may be achieved by adjusting the impedance or the capacitance of the RF-EH system 200.

RF-EH systems may comprise electronic tags of a very small size and low costs, which are battery and maintenance free.

The RF-EH system 200 may be configured to harvest and store energy coming from ambient RF signals. The RF-EH system 200 may include an Antenna 210, an “Impedance matching circuit” 220 allowing to maximize the power transfer from the antenna 210 to the load (this may be achieved when the load impedance is equal to the source impedance), a “Rectifier circuit” 230 allowing to convert AC to DC for storage of the energy, and a “Storage” 240, which may be a storage capacitor that acts as an energy reserve or a battery.

The stored energy can be used for various applications, including backscattering a signal, such as an incoming RF signal.

RFID (radio frequency identification) or passive communication technology may be used for backscattering incoming RF signals. However, these technologies are constrained in the amount of power they can radiate back. For a given radio source, the power at the receiving antenna falls off drastically with distance.

According to aspects, the RF-Energy Harvesting system or circuit 200 has been coupled to a RFID circuit, to use the extra amount of energy the Energy Harvester could provide (from previous ambient RF or incoming RF waves from a reading device), thus significantly improving the range of the backscattered RF by the RFID circuit.

The complete “RF-EH tag” in such kind of application includes the RF Energy Harvesting system combined with the RFID circuit or tag.

The RF harvested range may be wider than the RF range that is backscattered, allowing the RF-EH tag to harvest and store energy from multiple ambient sources, and use this stored energy to improve the backscattering of RF signals belonging only to a narrower RF range used by a dedicated device, such as the RF range used by the electronic device 110. The antenna for the harvesting may be designed for accepting a broader frequency range than the antenna used to backscatter an incoming RF signal.

FIG. 3 shows a schematic illustration of a tag 122 according to an aspect. The tag 122 may be comprised in a container.

The tag 122 may be powered by an RF-EH system, such as RF-EH system 200. The tag 122 may comprise a load modulator 310. The load modulator 310 may use a first load 312 and a second load 314 for modulating an input signal 130. The tag 122 may be configured to use amplitude modulation to backscatter the RF input signal 130, comprising a carrier wave. The tag 122 may be configured to modify the RF input signal such that the backscattered signal comprises data specific to the tag 122. The data specific to the tag 122 may comprise an identification value of a container, such as container 120. The tag may be in an absorption state, in which an incoming carrier data signal is completely absorbed such that a 0 is backscattered, or a reflection state, in which a 1 is backscattered. The tag 122 may go from the absorption state to the reflection state by adjusting an impedance that matches or mismatches respectively the input RF signal.

Additionally or alternatively, frequency modulation may be used by the tag 122.

By using the harvested energy, the range of a backscattered RF signal can reach a range of tens of meters indoor, which allows the users to have or place the container and the electronic device separately from each other for such a distance and still be able to authenticate the container. For instance, a user in an office could take a consumable from a pack, put the pack back into a bag or coat, which could be a few meters away, move back to his/her desk, plug the consumable to the electronic device, and only then start the electronic device, triggering the RF signal that will still be backscattered by the pack.

The RF-EH system of a container may be “energy charged” at factory time by using a compliant RF emitter. To do so, the frequency of the RF used at factory time to “charge” the RF-EH tags should be out of the range of the frequencies, which is backscattered by the RF-EH tags.

Even if a pack remains a somewhat long time unused before being used, its RF-EH system is able to function and provide its signal, as long as there are ambient RF signals. If the RF-EH has however not enough energy to provide a signal, users could be invited to activate an electronic device (if it's a RF emitting device) or a smartphone near the container, in order to charge the embedded RF-EH system, to allow it to send its signal afterwards.

The surface of a container may be used for the antenna 320 of the RF-EH system. The antenna 320 may assure a correct RF feeding and allow charging energy into the RF-EH system.

The antenna may be “printed” inside the container or packaging, or may be on a layer of the packaging material if it is laminated.

The input RF signal 130 comprising a carrier wave may be provided by another device (for instance, a smartphone) than the electronic device. The backscattered signal may be read by the other device, as long as this other device could process this backscattered signal and prevent at least one function of the electronic device.

According to aspects, the length of the backscattered signal could be adjusted according to the RFID technology. The signal provided by the tag may include an identifier, unique per container, proving that the container or consumable is genuine. Such an identifier may include, for instance, the Coidentity of the container/consumables in the container, or any other unique identifier. The identifier may be totally or partly encrypted.

According to a first option, only the container is authenticated. In this case, the backscattered signal may have a small length. The backscattered signal sent may be a unique identifier of the container, and may be sent along with a “Message Authentication Code” (MAC) of this identifier. The unique identifier of the container may be, for instance, a MIB (Manufacturing Information Block). The message authentication code may use a signature HMAC (hash-based MAC). Such a cryptographic function uses a secret key to create a hash of a message (“signature” of the message), such that the hash can be created only when using the secret key, allowing a recipient, also having the secret key, to verify the authenticity of the message, i.e. that the message's sender has the secret key.

Thus, even if a counterfactor knows the MIB of a container, or even if the counterfactor knows how to generate valid MIBs, it would be impossible for the counterfactor to create valid “signatures” associated with these MIBs.

To protect the authentication method, the secret key used by the HMAC could have been generated using a KDF (Key Derivative Function), such as HKDF.

KDF functions create cryptographic keys from a secret initial key (“Secret”) and non-secret parameter(s), diversifying the key used in the HMAC, such that even if the key used in the HMAC is discovered by an attacker, the initial Secret is still unknown and only the products using the same non-secret parameter(s) could be “attacked” (i.e., the attacker can create the HMAC signature of messages coming from the hacked product, creating false-positive authentication).

HKDF is a hash-based KDF type using HMAC-SHA as the hash function.

In aspects, one single Secret is used for all containers. Alternatively, there can be as many Secrets that there are different kinds (families) of packs or containers.

Hereafter, each kind of container may have a unique identifier PID determined according to a classification of the manufacturer packs or containers.

These Secrets may be shared with the electronic devices' manufacturers and be accessible to the electronic devices. Either all shared Secrets are recorded inside all electronic devices, or the electronic devices can securely connect to the electronic device's manufacturer server to retrieve the shared Secret using the PID. This may need to be done only once for each PID.

Furthermore, in order to decrease the effect of possible successful attacks, the non-secret parameter of the HKDF could be the MIB. By doing so, because the MIB (non-secret parameter) is unique per container, an attacker discovering the secret key used in the HMAC of a container could hack only the indicated container.

The signature generated by the HMAC could be truncated to decrease its length. The PID is an identifier unique per kind of container according to a classification of the containers by the container manufacturer. Secrets may be 32-byte (random) values, unique per PID, shared between the container manufacturer and the electronic device manufacturer. The MIB (Manufacturing Information Block) may be a numerical value that is unique per container.

For instance, it could be made by a concatenation of the container PID, container Manufacturing site ID (according to container manufacturer classification of the manufacturing sites), container Manufacturing Date and Time (format could be, for instance, Year, 3 digits, and week number on 2 digits), and a numerical value associated with the container unique in the manufacturing time frame for the manufacturing site.

Key Derivation Function (KDF) are functions that create one or more keys of determined format (these keys can be used for cryptographic purposes) from values provided in input.

Usually, the generated keys are used as parameters of a cryptographic function (for instance, AES). KDF is a deterministic algorithm (i.e., producing the same result when provided the same input). The indicated preferred HKDF is a KDF with a hash-based key derivation function (HMAC-SHA1 as the hash function).

A HKDF system uses a key, as well as parameters known as “Salt” and “Context” to derive new keys. Here, the MIB may be passed to the HKDF as the “Context”, and the “Salt” could be any fixed value, as long as it is a shared value between the container and the electronic device.

FIG. 4 shows a flow diagram of a method 410 for generating an encrypted identifier for a tag of a container, and the authentication method 450 performed by the electronic device according to an aspect.

A manufacturer of containers and consumables may manufacture a batch of containers and assign an encrypted identifier to the tags of the container. For encrypting the identifier of a tag of a container, a unique value PID may be determined for a container family in step 412.

In step 414, a unique MIB is generated per container. The MIB is a unique identifier per container, which includes the PID.

In step 416, a Secret or secret key is generated. The secret may be unique per PID.

In step 418, the secret key is shared with a manufacturer of the electronic device. The manufacturer of the container and consumables may be the same as the manufacturer of the electronic device for using or consuming the consumables.

In step 420, HKDF is used on the secret key and the MIB to generate a key for signature, such as KeyS.

In step 422, HMAC is used on the MIB, using KeyS to generate a signature S. The signature S may be truncated to receive a first truncated signature.

In step 424, the tag is configured to backscatter the MIB and the first truncated signature Ts in response to receiving an input signal.

In step 426, the electronic device retrieves the PID from the MIB.

In step 428, the secret key is determined based on the retrieved PID.

Then steps 420 and 422 are performed to obtain a second truncated signature Ts' based on the MIB obtained from the backscattered signal (step 430).

In step 432, it is determined whether the first truncated signature Ts equals or corresponds to the second truncated signature Ts'.

In step 434, the first truncated signature Ts equals or corresponds to the second truncated signature Ts' and the container is authenticated. In response to the container being authenticated, at least one function of the electronic device may be unlocked. For example, the electronic device may be capable of using a consumable after the container has been authenticated.

In step 436, the first truncated signature Ts is not equal or does not corresponds to the second truncated signature Ts', and the container is not authenticated. In response to the container being unauthentic or not genuine, at least one function of the electronic device may be locked or may remain locked, such that the electronic device is prevented from using a consumable.

Examples of values for encrypting the identifier:

| | | | Value for the example |
|---|---|---|---|
| Parameter name | Format | | (hexadecimal) |
| Secret (unique per PID) | 32 | bytes | 0x010203040506070809 |
| | | | 0a0b0c0d0e0f10111213 |
| | | | 1415161718191a1b1c1d1e1f20 |
| PID - Product ID (unique | 1 byte | | 0x01 |
| per kind of pack) | Max: 256 different kinds of | | |
| | pack | | |
| Manufacturing site ID | 1 byte | | 0x03 |
| | Max: 256 different sites | | |
| Manufacturing Date | 2 bytes | | 0x05ae |
| YYYWW (YYY year date | YYY: values go from 0 to | | (02246 for 46^{th} week of 2022) |
| three last digits, | 999, which can be coded in | | |
| WW: week number) | 10 bits (1024 values). | | |
| | WW: values go from 1 to 52, | | |
| | which can be coded in 6 bits | | |
| | (64 values). | | |
| | Total number of bits: 16. | | |
| Max number of packs per | 3 bytes | | 0x08d29b |
| week | Max: 16.7 million packs per | | (578.203^{th} unit the |
| | week | | indicated week) |
| MIB values array: | 7 | bytes | 0x010305ae08d29b |
| PID + Manuf site ID + Manuf | | | |
| Date + number | | | |
| KeyS (HKDF generated | 32 | bytes | 0x48d392636e8b16d9987b1 |
| using Secret and MIB) | | | 971978a51f13a938d2d29c52 |
| HKDF using SHA 256. | | | 1768a387319a5d6d6c9 |
| S (HMAC of MIB using the | 32 | bytes | 0x119a68a3a2f2125fa0de96d |
| Signature Key) | | | 43c60eb74c674192e88ae9f798 |
| HMAC using SHA 256. | | | 566fe2f57c2ac35 |
| Ts = truncated S (for | 5 bytes | | 0x119a68a3a2 |
| instance only the first 5 | (max different signatures: | | |
| bytes) | more than 1 billion) | | |
| Total message | 12 | bytes | 0x010305ae08d29b119a68a3a2 |
| backscattered: MIB + Ts | | | |

In case a valid RF-EH tag is copied by a counterfactor and used for several counterfeit packs, electronic devices would record multiple packs having the same “authenticated” MIB, which is not possible. Such a case can trigger an alarm for the electronic device manufacturer. The electronic devices can then be prevented to function with this MIB. From that point in time, the counterfactor (and his clients) would not be able to use the counterfeit containers, creating financial losses for them, and inciting them to stop counterfeiting the protected packs.

In an aspect according to a second option, the backscattered signal provides confidential information for the electronic device. For example, the confidential information may comprise parameters for the electronic device to be applied to the electronic device to optimize the consumption of the consumables in the container. Such optimization of the consumption could be, for instance, to indicate the best temperature profile for a specific sensorial media, which is used in a kind of consumable. The electronic device, such as an RRD device, may be able to adjust a temperature profile for heating a consumable.

In such a case, the identification signal may comprise the following data: an Encrypted Message (EMS), a Generic ID (GID) of the kind of consumable (contextualizing the information of the encrypted message to the specific kind of consumable upon which this information should be used), and a unique identification value of the container, for instance, a MIB (Manufacturing Information Block) for the container authentication.

The EMS may be created by using a symmetric-key algorithm, for instance, AES 128 to encrypt an Initial Message (IMS) using a Major Key generating the EMS.

The Major Key may be created by using a shared Secret common to all packs of the same kind of consumables (i.e., having the same GID) and the MIB processed into a KDF (Key Derivative Function), such as HKDF.

The electronic device when reading the EMS, GID and MIB from the signal can retrieve the shared secret associated to the GID. All shared secrets may be recorded inside all electronic devices. Alternatively, the electronic device may be configured to securely connect to the manufacturer server to retrieve the shared secret by providing the GID. This needs to be done only once for each GID. Then, the device creates the Major Key using the KDF, the shared secret and the MIB. Then, the symmetric-key algorithm may be used to decrypt the EMS to get the IMS.

The IMS could include at least a part of the GID and/or the MIB to confirm a correct decryption, and that the container is genuine.

The IMS may also comprise additional data to help classify the consumables in the pack and to optimize their aerosolization. In case the decrypt process is not valid, the electronic device could stop working and indicate the problem details via an interface.

The GID could be chosen among an array of numerical values used by the consumables or container manufacturer to classify its products into families of products, each family sharing common characteristics (consumable format, geographical localization, etc.).

For instance, and only for illustration, all cut-filler products in slim cigarette articles using induction heating sold in Asia could have the same specific value for their GID.

The Advanced Encryption Standard, AES, is a symmetric-key algorithm allowing to encrypt/decrypt a message using specified keys. Symmetric means that the same keys are used for both encrypting and decrypting the message. These keys can be shared by the encrypting and the decrypting parties.

One of the keys used by AES for encrypting/decrypting, usually called an initial value (IV), may be changed from one message to encrypt to the next, in order to increase protection.

Since only one signal is encrypted, the IV may be fixed as long as it is shared by the encrypting & decrypting parties. Accordingly, the IV may be a number, or a number related to the GID, or even, a number coming from the key generated by HKDF. The IV could be of any kind among the ones indicated, as long as it is a shared value or process.

Examples of values for option 2:

| | | | Value for the example |
|---|---|---|---|
| Parameter name | Format | | (hexadecimal) |
| Secret (unique per GID) | 32 | bytes | 0x010203040506070809 |
| | | | 0a0b0c0d0e0f10111213 |
| | | | 1415161718191a1b1c1d1e1f20 |
| PID - Product ID (unique | 1 byte | | 0x01 |
| per kind of pack) | Max: 256 different kinds | | |
| | of pack | | |
| GID - Generic ID of the kind | 1 byte | | 0x05 |
| of consumable | Max: 256 different | | |
| | families of products | | |
| Manufacturing site ID | 1 byte | | 0x03 |
| | Max: 256 different sites | | |
| Manufacturing Date | YYYWW (YYY year date | | 0x05ae |
| | three last digits, WW: | | (02246 for 46^{th} week of 2022) |
| | week number): 2 bytes | | |
| | YYY: values go from 0 | | |
| | to 999, which can be | | |
| | coded in 10 bits (1024 | | |
| | values). | | |
| | WW: values go from 1 to | | |
| | 52, which can be coded | | |
| | in 6 bits (64 values). | | |
| | Total number of bits: 16. | | |
| Max number of packs per | 3 bytes | | 0x08d29b |
| week | Max: 16.7 million packs | | (578.203^{th} unit the indicated |
| | per week | | week) |
| MIB values array: | 7 | bytes | 0x010305ae08d29b |
| PID + Manuf ID + | | | |
| ManufDate + number | | | |
| Major key (HKDF generated | 32 | bytes | 0x48d392636e8b16d9987b1 |
| using Secret and MIB) | | | 971978a51f13a938d2d29c52 |
| HKDF using SHA 256. | | | 1768a387319a5d6d6c9 |
| IV ((HKDF generated using | 1 | byte | 0x2f |
| Secret and MIB) | | | |
| HKDF using SHA 256. | | | |
| Info to be added to IMS | 5 bytes | | “Hello” (in hexadecimal: |
| | (more than 1 billion | | 0x48656c6c6f) |
| | values) | | |
| IMS: | 8 | bytes | 0x01052f48656c6c6f |
| 1^{st} byte of MIB, GID, | | | |
| IV + Info | | | |
| EMS (AES generated) | 32 | bytes | 0xe6dcc289f7a67e789ed12fa |
| | | | 0369cdd01a4302830106552ce |
| | | | ad5c183c86c508b7 |
| Data sent: | 32 + 7 + 1 = 40 bytes | | 0xe6dcc289f7a67e789ed12fa |
| EMS + MIB + GID | | | 0369cdd01a4302830106552ce |
| | | | ad5c183c86c508b7 |
| | | | 010305ae08d29b05 |

This encryption ensures that the IMS can be kept quite secret and secure, and may make the system difficult to counterfeit.

Furthermore, in case a counterfeiter reproduces the EMS, GID and MIB of one pack, and creates several counterfeit packs having these same values, the counterfeit items may be limited to the GID/IMS kind of consumables of the pack, and cannot be used for all kinds of consumables that are compliant with the electronic device.

According to an aspect, when starting the electronic device to heat a consumable, the electronic device sends a RF signal and awaits a backscattered RF signal by the container via the RF-EH system in combination with the tag. The backscattered signal allows the electronic device to identify the pack as genuine or not. If the pack is genuine, the electronic device operates normally (and possibly uses additional information of the backscattered signal to optimize the heating of the consumable). Otherwise, the electronic device does not function and indicates the reason via an interface, such as not recognized consumable or container.

Aspects prevent from counterfeit consumables, as a genuine pack has to be provided in proximity of the RRP device each time the RRP device is used. However, it is still possible to use counterfeit consumables when carrying (or in proximity of) at least one genuine pack.

To limit such a counterfeit option, the electronic device associated with each pack ID credits the electronic device with a specific number of consumables—the number somehow expected per each container—preventing a single genuine pack to be used over and over again with counterfeit consumables. The electronic device can subtract one unit from the credited number of consumables each time it heats a consumable.

According to aspects, when starting the electronic device to heat a consumable, the electronic device sends a RF signal and awaits the backscattering by the pack via the RF-EH system. The backscattered signal allows the electronic device to identify the container as genuine or not. If the container is genuine, the electronic device checks (in its own memory or by connecting to the manufacturer server via a smartphone) how many times the ID of the pack has been used, for instance, to compare the reported use of the RRP device function with the expected number of consumables for this kind of pack. In case the number of consumables associated with a pack has not yet been reached, the electronic device may be configured to operate and heat the consumable.

In case the number of consumables associated with a pack has been reached, the electronic device does not function and indicates a reason via its interface, such as not recognized consumable/container, no more credited consumables left for the genuine pack ID, etc.

Additionally, to prevent a user from activating such an option in a store where there are multiple packs, only one new pack ID may be recorded per determined time duration (for instance, per hour). This limits counterfeits, as a genuine container and a positive number of credited consumables would be provided for the electronic device to start heating a consumable.

According to an aspect, the RF backscattering is generated ONLY when a container is open (“unsealed”). Accordingly, a user cannot falsely increase his/her consumable credits by going in a store where there are genuine packs, as these packs are sealed in a store. Heating a consumable with the electronic device is only possible by providing, at proximity of the RRP device, a genuine open/unsealed pack.

An option is to have one of the current lines of the RF-EH tag creating a short cut of the backscattered signal, so that this current line is cut open when unsealing/opening the pack. As long as the pack is closed/sealed, the current line creates a short cut and draws all electrical signals created by the RF-EH tag so that no adjusted electrical signal goes to the antenna to be back scattered (constant absorption state). It can also be done with a constant reflection state.

In this aspect, only when the short cut line is open, the backscattered signal becomes available. An option is to have this short cut line running on a piece of the RF-EH tag that is torn off when opening the container cap.

FIG. 5 shows a circuit suppressing the backscattered signal of the tag as long as the lines on the left of the tearing line 520 are connected to the Load modulator 310 (these lines connect the antenna 320 directly to the ground, bypassing the load modulator). Such current “extra” lines could be printed on a paper/carton part of the tag that is torn when the pack is open. When doing so, the part on the left of the “Tearing line” 520 may be suppressed, the load modulator becomes functional and the RF-EH tag backscatters its signal. Other options could be to have just one line bypassing one of the loads (creating a constant absorption or reflection state).

FIG. 6 shows a container 120 with a tag 122. The tag 122 may be under the cap material of the cap 524. The tag 120 may join the inside of the cap with the body of the container 120. “Extra” lines may be connected to the tag for preventing the tag to backscatter RF signals. The extra lines will be cut from the tag when the cap 524 is opened. Such a system could be used in a cap securing a bottle, etc.

According to aspects, the tag backscatters a first signal when the container is closed (“sealed”) and a second signal when the container is opened (“unsealed”). For example, the first signal and the second signal may differ in at least one bit. The at least one bit may indicate the change from sealed to unsealed in the container.

The electronic device, for it to be credited of the consumables in a container, may detect a sequence of signals, the sequence of signals comprising receiving the first signal, and then, the second signal.

FIG. 7 shows a flow diagram of a method 700 for receiving a credit for using consumables according to an aspect.

In step 702, the electronic device may be put into a first mode related to the opening of a new or sealed container of consumables. The first mode may be an “Open Pack” mode. The electronic device may be in one of at least two modes. A user of the electronic device may put the electronic device in the first mode.

In step 704, the electronic device being in the first mode may send a first RF signal to a tag of a container. The container may be closed or sealed and the tag of the container backscatters the first RF signal to the electronic device (step 706).

In step 708, the electronic device receives the backscattered first RF signal and may at least one of check, validate and record an identifier comprised in the backscattered first RF signal.

The backscattered first RF signal may comprise an indication that the container is sealed.

The user of the electronic device may open the container as indicated in step 710.

In step 712, the electronic device, which may be in the first mode, sends a second RF signal to the tag of the container.

In step 714, the tag receives the second RF signal and backscatters the second RF signal.

The backscattered second RF signal may comprise the identifier of the container. Additionally, the backscattered second RF signal may comprise an indication that the container is unsealed.

In step 716, the electronic device recognizes the identifier and detects a transition of the container from a “sealed” to an “unsealed” state. In response to detecting the transition, the electronic device may receive credits for the identifier. The number of credits may correspond to a maximum number of consumables in the container, such as 20 consumables for the container ID.

The user of the electronic device may insert a consumable in the electronic device for usage as shown in step 718. The user may start a second mode relating to the usage of the consumable. Alternatively, the second mode, such as a “heat mode”, may be selected automatically when the user inserts the consumable in the electronic device.

In step 720, the electronic device, which may be in the second mode, sends a third RF signal to the tag of the container.

In step 722, the tag receives the third RF signal and backscatters the third RF signal. The backscattered third RF signal comprises the identifier of the container. Additionally, the backscattered signal may comprise an indication that the container is unsealed.

In step 724, the electronic device receives the backscattered signal comprising at least one of the identifier and an indication of the state of the container. The electronic device may check that this identifier is recorded and that a positive consumables credit is associated with the identifier in the electronic device. The consumables credits may be decreased by 1. The dashed lines in FIG. 7 indicate that a user of the electronic device may perform steps 702, 710 and 718, steps 704, 708, 712, 716, 720 and 724 may be performed by the electronic device, and steps 706, 714 and 722 may be performed by the container or a tag of the container.

According to an aspect, a user may transfer credited consumables from one electronic device to another. The credited consumables may be transferred via Internet or a dedicated app, or by using a specific “Lend/Borrow” mode on the electronic devices (where, for instance, the number of consumables credited as well as the source/target electronic devices are indicated).

According to aspects, the backscattered signal may provide information regarding a parameter of the electronic device to apply to optimize the consumption of the consumables in the packaging.

In case of cigarette-like consumables, the packaging usually includes an inner liner, which is a metallic coated container, improving the sealing of the consumables. In such a case, the metal layer of the inner liner could be printed (or metal could be suppressed via laser de-coating) to design the antenna of the RF-EH system. This provides a large surface, which improves harvesting of the RF-EH system.

According to aspects, the tag may be a RFID tag. Such aspects may be less interesting as the RFID tag's distance to backscatter signals is very small (usually a few mm for the kind of energy expected from the RF of RRP device).

According to an aspect, a smartphone is used to send dedicated ambient RF to the RF-EH tags to charge such tags (i.e., to participate to the ambient RF signals using specific RF frequencies adjusted to the architecture of the RF-EH tag used in the pack, increasing the harvesting), as well as to send a RF signal (for instance, if the smartphone can send a more powerful carrier wave than the electronic device) that could be backscattered to the smartphone and/or the electronic device.

According to aspects, a used pack is re-filled with consumables and re-initialized (for instance, by receiving a new tag or by having its tag ID reset) by the manufacturer/dedicated shops, and re-“sealed”, increasing the sustainability of the solution.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1. A system comprising:
an electronic device configured to consume consumables; and
a container configured to store consumables, the container comprising a tag,
wherein the electronic device is configured to read an identifier from the tag, and
wherein the electronic device is configured to unlock, based on the identifier, at least one function of the electronic device,
wherein the container comprises a radio-frequency energy harvesting, RF-EH, system to power the tag, wherein the RF-EH system comprises an antenna.

2. The system according to claim 1, wherein at least one of:
the antenna of the RF-EH system is printed on at least one surface of the container,
the antenna of the RF-EH system is printed on at least one inner surface of the container,
the antenna of the RF-EH system is a layer of packaging material of the container,
the antenna of the RF-EH system is comprised in at least one of the walls of the container,
the antenna of the RF-EH system is deposed in the cardboard of the container, and
the antenna of the RF-EH system is comprised in an inner liner of the container, wherein
the inner liner comprises metal.

3. The system according to claim 1, wherein the electronic device comprises an aerosol-generating device and is configured to unlock, based on the identifier, at least one function of the aerosol-generating device in response to reading the identifier, wherein the consumables comprise aerosol-generating articles, and wherein the aerosol-generating device is configured to engage with an aerosol-generating article of the aerosol-generating articles, and wherein the electronic device is configured to heat the aerosol-generating article only when a container is authenticated based on the identifier.

4. The system according to claim 1, wherein the identifier is used only a limited amount of times to unlock the at least one function, wherein the limited amount of times corresponds to a maximum number of consumables in the container.

5. The system according to claim 1, wherein the container is configured to transition from a sealed state to an unsealed state when the container is opened for the first time, and
wherein one of:
the identifier is only read in the unsealed state, and
the electronic device is configured to read information about whether the state of the container is sealed or unsealed from the tag, and wherein the electronic device is configured to unlock the at least one function of the electronic device based on the identifier only when the information about whether the state of the container is sealed or unsealed indicates that the container is unsealed.

6. The system according to claim 1, wherein at least a part of the identifier is encrypted, and wherein the electronic device is configured to decrypt the encrypted identifier after reading the encrypted identifier.

7. The system according to claim 1, wherein the electronic device is configured to:
send a radio frequency signal to the container, and
receive a backscattered signal from the container to read the identifier from the tag, the backscattered signal comprising the identifier,
wherein the electronic device is configured based on information comprised in the backscattered signal.

8. The system according to claim 1, wherein the RF-EH system comprises an impedance matching circuit, a rectifier configured to convert alternating current, AC, to direct current, DC, and the energy storage.

9. A method for using consumables with an electronic device, the method comprising:
requesting, by an electronic device for using consumables, usage of a consumable from a container storing consumables by sending a radio frequency signal to a tag of a container;
receiving, by the electronic device, a backscattered signal from the tag of the container, wherein the backscattered signal comprises an identifier identifying at least one of the consumable and the container; and
operating the electronic device to use the consumable when the at least one of the consumable and the container is identified based on the received identifier,
wherein the container comprises a radio-frequency energy harvesting, RF-EH, system for providing energy for the tag for backscattering the radio frequency signal.

10. The method according to claim 9, wherein the backscattered signal comprises information associated with the consumables, and wherein the method comprises configuring the electronic device based on the information.

11. The method according to claim 10, wherein the consumables comprise aerosol-generating articles, wherein the electronic device comprises an aerosol-generating device configured to engage with an aerosol-generating article of the aerosol-generating articles, and wherein the information comprises an indication of a heat profile for heating the consumable.

12. The method according to claim 9, comprising blocking at least one functionality of the electronic device making the electronic device unable to use the consumable, in response to not receiving the backscattered signal or determining, based on the identifier, that the identified at least one of the consumable and the container is a counterfeit product.

13. The method according to claim 9, wherein the operating the electronic device to use the consumable is limited to a predetermined number of times for the identifier.

14. The method according to claim 9, wherein one of:
i) the backscattered signal from the tag is only received when a state of the container has been transitioned from a sealed state to an unsealed state, wherein the transitioning from a sealed state to an unsealed state comprises one of:
opening a current line connected to the tag when the container is opened for the first time, the current line creating a short cut preventing the tag from backscattering a signal,
activating a load modulator of the tag, when the container is opened for the first time, and
opening a current line bypassing one load of the tag when the container is opened for the first time, the current line creating a shortcut preventing the tag from backscattering a signal, and
ii) the backscattered signal comprises information about a state of the container, wherein the state is one of a sealed state and an unsealed state, and wherein the electronic device is only operated to use the consumable when the container is in the unsealed state.

15. The method according to claim 9, wherein at least one setting of the electronic device is configured based on the identifier, wherein the configuring comprises selecting a temperature profile from a plurality of temperature profiles and operating the electronic device in accordance with the selected temperature profile for the consumables of the container.
